(19) United States
(12) Patent Application Publication
(10) Pub. No.: US 2026/0090555 A1
(43) Pub. Date: Apr. 2, 2026

(54) STERILIZED FERMENTED MILK AND PRODUCTION METHOD THEREFOR

(71) Applicant: MEIJI CO., LTD., Tokyo (JP)

(72) Inventors: Takefumi ICHIMURA, Tokyo (JP); Megumi TADA, Tokyo (JP)

(73) Assignee: MEIJI CO., LTD., Tokyo (JP)

(21) Appl. No.: 19/110,201

(22) PCT Filed: Sep. 13, 2023
(86) PCT No.: PCT/JP2023/033459

§ 371 Date: Mar. 10, 2025

(30) Foreign Application Priority Data
Sep. 14, 2022 (JP) 2022-146606

(51) Int. Cl. A23C 9/123

(52) U.S. Cl. CPC A23C 9/123

(57) ABSTRACT

The present invention provides firm set-type pasteurized fermented milk. The set-type pasteurized fermented milk of the present invention has curd tension (X) and particle size after stirring (Y) that satisfy the following conditions: a curd tension (X) of 20 g to 220 g, a particle size after stirring (Y) of 166.5 μm to 2.5 μm, and Y≤−0.82X+183.

### CROSS-REFERENCE TO RELATED PATENT APPLICATION

The present application claims priority based on Japanese Patent Application No. 2022-146606, filed on Sep. 14, 2022, the entire disclosure of which is incorporated herein by reference.

### TECHNICAL FIELD

The present invention relates to set-type pasteurized fermented milk and a production method for the set-type pasteurized fermented milk. More specifically, the present invention relates to set-type pasteurized fermented milk that is packed in a container, then fermented (post-fermented), and made firm within the container, and a production method for the set-type pasteurized fermented milk.

### BACKGROUND ART

Pasteurized fermented milk refers to fermented milk that is produced by heating at 75° C. for at least 15 minutes after fermentation, or by pasteurization according to a method that exerts an equivalent or greater antimicrobial effect (Ministerial Ordinance Concerning Compositional Standards, etc. for Milk and Milk Products, Ministry of Health and Welfare Ordinance, No. 52 of 1951, revised on Jan. 9, 2015 (“Ministerial Ordinance on Milk and Milk Products” below): Ministry of Health, Labour and Welfare of Japan). Regular fermented milk, which contains live lactic acid bacteria, undergoes changes in taste and sourness over time, and also shows syneresis as the acidity increases. In contrast, pasteurized fermented milk has a long shelf life and undergoes less change in flavor during storage due to the death of microorganisms, including lactic acid bacteria, and is thus in high demand in the market.

However, pasteurization of starting-material milk after fermentation allows the milk proteins to coagulate and precipitate. For this reason, a method has been used in which the stabilizer as described below is added to fermented milk, which then undergoes pasteurization while being stirred and circulated with a stirrer to suppress coagulation and precipitation during pasteurization: stabilizers are those such as HM pectin, LM pectin, gelatin, carrageenan, xanthan gum, methylcellulose, sodium carboxymethylcellulose, hydroxypropyl methylcellulose, sodium polyacrylate, curdlan, dextran, tamarind gum, guar gum, tara gum, locust bean gum, glucomannan, gum arabic, gellan gum, alginic acid, sodium alginate, calcium alginate, ammonium alginate, potassium alginate, propyl glycol alginate, tremel gum, agar, potato starch, tapioca flour, cellulose, fermented cellulose, brown algae extract, enzymatic decomposed products of guar gum, gluten, decomposed products of gluten, soybean hemicellulose, Abelmoschus manihot, acetylated distarch adipate, acetylated oxidized starch, acetylated distarch phosphate, starch sodium octenylsuccinate, starch acetate, oxidized starch, sodium starch glycolate, hydroxypropyl distarch phosphate, hydroxypropyl starch, distarch phosphate, monostarch phosphate, and phosphated distarch phosphate.

For example, PTL 1 discloses that a β-glucan-containing material (Aureobasidium culture fluid) is added as a stabilizer after fermentation, followed by pasteurization, and that homogenization by mixing following pasteurization is performed to liquefy the mixture. PTL 2 discloses that in a production method for fermented milk in which a milk preparation containing dairy ingredients, crosslinked modified starch (stabilizer), and fermenting bacteria is fermented to a pH of 5.3 to 6, followed by pasturing the resulting fermented product, pasteurization is performed while the fermented product in a curd form is broken with stirring, and then the resulting fermented milk is packed in containers.

As described above, all of the existing pasteurized fermented milk products and those disclosed in literature are of either gelatinized, soft type or liquid drink-type produced by breaking the curd after fermentation. There has been no firm set-type fermented milk so far.

### CITATION LIST

### Patent Literature

PTL 1: JP2005-137245A
PTL 2: JP2017-63727A

### SUMMARY OF INVENTION

### Technical Problem

An object of the present invention is to provide set-type pasteurized fermented milk, specifically, firm pasteurized fermented milk produced through packing in a container, fermentation (post-fermentation), and solidification in the container, and to provide a production method for the set-type pasteurized fermented milk. More specifically, the object of the invention is to provide set-type pasteurized fermented milk in which the coagulation of milk proteins occurring during post-fermentation heat treatment is suppressed, and to provide a method for producing the set-type pasteurized fermented milk.

### Solution to Problem

The present inventors conducted extensive research to produce set-type pasteurized fermented milk that has achieved the object above and found that fermenting a starting-material milk mix containing lactic acid bacteria in a container at 37° C. to 43° C. until the pH reaches 3.8 to 5.4, and then heating the mixture in heat history of 75° C. for 15 minutes or more without breaking the curd can even provide firm pasteurized fermented milk with suppressed coagulation of milk proteins and a smooth texture.

The present invention was completed based on the finding above and includes the following embodiments.

### (I) Set-Type Pasteurized Fermented Milk

(I-1) A set-type pasteurized fermented milk having curd tension (X) and particle size after stirring (Y) that satisfy the following conditions:
a curd tension (X) of 20 g to 220 g,
a particle size after stirring (Y) of 166.5 μm to 2.5 μm, and

$$Y \leq - 0.82 X + 183.$$

(I-2) The pasteurized fermented milk according to (I-1), wherein the curd tension (X) is 35 g or more.

(I-3) The pasteurized fermented milk according to (I-1) or (I-2), comprising fat in an amount of 6 mass % or less and non-fat milk solids in an amount of 8 to 16 mass %, and having a pH of 3.8 to 5.4,
with the proviso that the pasteurized fermented milk containing the non-fat milk solids in an amount of 15 mass % or more and the fat in an amount of 0.5 mass % or less or the pasteurized fermented milk containing the non-fat milk solids in an amount of 15 mass % or more and containing no externally added saccharide has a pH of 3.8 to 4.5.

(I-4) The pasteurized fermented milk according to (1-3), comprising a saccharide in an amount of 15 mass % or less.

### (II) Method for Producing Set-Type Pasteurized Fermented Milk

(II-1) A method for producing the pasteurized fermented milk of any one of (I-1) to (I-4), comprising the steps of
fermenting a starting-material milk mix to which lactic acid bacteria are added in a container at 37° C. to 43° C. until the pH reaches 3.8 to 5.4 (fermentation step), and
heating the obtained fermented milk together with the container (heat treatment step).

(II-2) The method according to (1-2), wherein the starting-material milk mix is subjected to homogenization and pasteurization before the lactic acid bacteria are added.

(II-3) The method according to (II-1) and (II-2), further comprising, before the fermentation step, the step of homogenizing and pasteurizing the starting-material milk mix before the lactic acid bacteria are added.

(II-4) The method according to any one of (II-1) to (II-3), wherein the starting-material milk mix contains fat in an amount of 6 mass % or less and non-fat milk solids in an amount of 8 to 16 mass %,
with the proviso that
   when the starting-material milk mix contains the non-fat milk solids in an amount of 15 mass % or more and the fat in an amount of 0.5 mass % or less, or when the starting-material milk mix contains the non-fat milk solids in an amount of 15 mass % or more and contains no externally added saccharide, the starting-material milk mix is fermented until the pH reaches 3.8 to 4.5.

(II-5) The method according to (II-4), wherein the starting-material milk mix contains a saccharide in an amount of 15 mass % or less.

### Advantageous Effects of Invention

The production method of the present invention produces and provides set-type pasteurized fermented milk. Preferably, the production method of the present invention produces and provides firm pasteurized fermented milk that is easily disintegrated with the tongue in the mouth and that has a smooth texture without any graininess, by using a post-fermentation method.

The pasteurized fermented milk produced according to the production method of the present invention is firm set-type pasteurized fermented milk, but is easily disintegrated by the tongue in the mouth and has a smooth texture without any graininess, as with fermented milk produced without pasteurization.

### BRIEF DESCRIPTION OF DRAWINGS

FIG. 1 is a graph plotting the textures (O, x) of the pasteurized fermented milk of Examples 1 to 16 and the pasteurized fermented milk of Comparative Examples 1 to 6 with curd tension (g) on the horizontal axis and particle size after stirring (μm) on the vertical axis.

### DESCRIPTION OF EMBODIMENTS

### (I) Set-Type Pasteurized Fermented Milk

Fermented milk is defined in the Ministerial Ordinance Concerning Compositional Standards, etc. for Milk and Milk Products (Ministerial Ordinance on Milk and Milk Products) as being “the products which are obtained by fermenting milk, or milk, etc. containing an equal or greater amount of milk solids-not-fat with lactic acid bacteria or yeast and then forming a paste or liquid, or the frozen product” with the milk solids-not-fat set to 8.0% or more. These fermented milk products are broadly classified into the following: (a) firm fermented milk obtained by filling a container with starting-material milk, fermenting it, and solidifying it within the container (which is called “set-type fermented milk” or “post-fermented milk”); (b) gelatinized fermented milk obtained by performing fermentation in a large tank or the like, breaking the curd formed, mixing it with fruit pulp, sauce, etc. as necessary, and packing it in a container (which is called “soft yogurt” or “pre-fermented milk”); and (c) liquid fermented milk obtained by finely crushing the firm fermented milk or gelatinized fermented milk with a homogenizer or the like to liquefy it, mixing it with fruit pulp, sauce, etc. as necessary, and packing it in a container (which is called “drink yogurt”).

The fermented milk targeted by the present invention is, among these fermented milk products, set-type (firm) fermented milk that has been post-fermented using lactic acid bacteria. The fermented milk targeted by the present invention is also fermented milk that has been pasteurized by heat treatment after fermentation (“pasteurized fermented milk”). Specifically, the fermented milk targeted by the present invention is fermented milk that is produced by performing fermentation and then heating at 75° C. for at least 15 minutes, or performing pasteurization using a method that exerts an equivalent or greater antimicrobial effect.

Normally, fermented milk pasteurized under the heat history conditions described above after fermentation undergoes coagulation of milk protein, which results in a grainy texture and causes precipitation and syneresis, failing to become a product of marketable quality. Thus, a commonly used method is heating the curd formed after fermentation while crushing the curd. In contrast, the pasteurized fermented milk of the present invention has coagulation of milk protein suppressed and has no grainy texture despite being set-type (firm) pasteurized fermented milk obtained by heating the curd formed after fermentation under the heat history conditions described above without crushing the curd. Additionally, the pasteurized fermented milk of the present invention gives a mouthfeel unique to yogurt (a texture that disintegrates easily upon contact with the tongue in the mouth).

The pasteurized fermented milk of the present invention having these characteristics satisfies the following requirements:
Curd tension (X): 20 g to 220 g
Particle size after stirring (Y): 166.5 μm to 2.5 μm

Y≤−0.82X+183

The phrase “curd tension” as used herein refers to the firmness (g) of pasteurized fermented milk adjusted to a product temperature of 5° C., and can be measured with a MAX ME-500 curd meter (produced by I. Techno Engineering) in the manner described in the Examples below. A yogurt knife with a 100 g weight attached is inserted into a test sample (pasteurized fermented milk) from the top surface with a load of about 2 g/sec, and the load applied until the test sample breaks is measured as the curd tension (g). Details, including the measurement conditions, are as described in the Examples.

The range of curd tension is as described above, but is preferably 35 g or more. By adding a curd tension of 35 g or more to pasteurized fermented milk, it is possible to provide pasteurized fermented milk that is able to withstand vibrations during transportation while having a desired texture (mouthfeel). More preferably, the curd tension is 40 g or more. The upper limit of the curd tension is preferably 200 g, more preferably 180 g, even more preferably 175 g, and particularly preferably 140 g. A preferable range of curd tension can be set by combining these lower and upper limits as appropriate. An example of the range of curd tension is, but not limited to, 35 to 200 g, 40 to 180 g, 40 to 175 g, or 40 to 140 g. Pasteurized fermented milk with curd tension within these ranges has a more preferable texture (mouthfeel).

The “particle size after stirring” refers to the particle size as measured by subjecting pasteurized fermented milk adjusted to a product temperature of 5° C. to predetermined stirring treatment according to the method described in the Examples below and measuring the resulting stirred product with a SALD-2200 laser diffraction particle size distribution analyzer (produced by Shimadzu Corporation). Details, including the measurement conditions, are as described in the Examples.

The range of the particle size after stirring is as described above, but is preferably 150 μm or less, more preferably 145 μm or less, and particularly preferably 100 μm or less. The lower limit of the particle size after stirring is preferably 20 μm, more preferably 30 μm, and particularly preferably 35 μm. A preferable range of particle size after stirring can be set by combining these lower and upper limits as appropriate. An example of the range of particle size after stirring is, but not limited to, 20 to 150 μm, 30 to 145 μm, or 35 to 100 μm. Pasteurized fermented milk having a particle size after stirring within these ranges has a more preferable texture (not grainy).

It is preferred that the pasteurized fermented milk of the present invention contain fat in an amount of 6.5 mass % or less, preferably 6 mass % or less, and non-fat milk solids in an amount of 8 to 16 mass %, per 100 mass % (wet mass) of the pasteurized fermented milk, and have a pH of 3.8 to 5.4. Additionally, the pasteurized fermented milk of the present invention preferably contains a saccharide in an amount of 15 mass % or less.

The pasteurized fermented milk of the present invention includes pasteurized fermented milk having the following compositions and pH:
(a) a fat content of 0.1 to 6.5 mass %, preferably 0.5 to 6 mass %, and more preferably 1 to 4 mass %; a non-fat milk solids content of 8 to 16 mass %, preferably 8.5 to 15.5 mass %, and more preferably 8 to less than 15 mass %; a saccharide content of 5 to 15 mass %, preferably 5 to 13 mass %, and more preferably 5 to 12 mass %; and a pH of 4.5 to 5.4, preferably 4.5 to 5.2, and more preferably 4.5 to 5.0;
(b) a fat content of more than 0.5 mass % and 4 mass % or less, preferably 1 to 3.5 mass %; a non-fat milk solids content of 15 to 16 mass %, preferably more than 15 mass % and less than 16 mass %; a saccharide content of 5 to 10 mass %, preferably 7 to 9 mass %; a pH of 3.8 to less than 4.5, preferably 4.0 to 4.4; preferably with the saccharide being lactose derived from starting-material milk, containing no other saccharides (externally added saccharides); and
(c) a fat content of 0.5 mass % or less, preferably 0.1 to 0.5 mass %; a non-fat milk solids content of 15 to 16 mass %, preferably more than 15 mass % and less than 16 mass %; a saccharide content of 5 to 15 mass %, preferably 8 to 15 mass %, and a pH of 3.8 to less than 4.5, preferably 4.0 to 4.4.

The pasteurized fermented milk of the present invention preferably does not include pasteurized fermented milk having the following compositions and pH:
(d) a non-fat milk solids content of 15 mass % or more and a fat content of 0.5 mass % or less, with a pH of 4.7 to 5.4; and
(e) a non-fat milk solids content of 15 mass % or more, a fat content of more than 0.5 mass % and 4 mass % or less, containing no saccharides (externally added saccharides) other than lactose derived from starting-material milk, with a pH of 4.7 to 5.4.

The fat content in pasteurized fermented milk can be analyzed and measured according to the Roese-Gottlieb method. The proportion of non-fat milk solids contained in pasteurized fermented milk can be calculated by subtracting the amount of fat measured according to the method above and water from the entire amount of the pasteurized fermented milk. The water content in pasteurized fermented milk can be determined by calculating the solids concentration (mass %) according to a direct drying method and subtracting the result from the entire amount taken as 100 mass %.

The saccharides described above include lactose derived from starting-material milk, as well as externally added saccharides not derived from the starting-material milk, specifically monosaccharides, disaccharides, oligosaccharides, polysaccharides, and sugar alcohols. Note that the starting-material milk (milk, milk components, and dairy products) basically does not contain saccharides other than lactose. However, this does not apply if starting-material milk has been treated with lactase or other enzymes to break down lactose.

The externally added saccharides are preferably saccharides, such as monosaccharides and disaccharides (externally added sugars). Without limitations, monosaccharides include glucose, fructose, and galactose; disaccharides include sucrose, maltose, lactose, and trehalose; oligosaccharides include fructooligosaccharides, soybean oligosaccharides, raffinose (beet oligosaccharides), galactooligosaccharides, and isomaltooligosaccharides; polysaccharides include EPS (exopolysaccharides), and pectin; and sugar alcohols include xylitol, sorbitol, and maltitol. The pasteurized fermented milk of the present invention may be free of externally added saccharides (preferably externally added sugars); however, when externally added saccharides (preferably externally added sugars) are blended, the amount is preferably, but not limited to, 6 mass % or less.

The proportion of lactose in the saccharides contained in pasteurized fermented milk can be analyzed and measured by using a commercially available measurement reagent kit (F-kit lactose/D-galactose: JK International Inc.). When pasteurized fermented milk contains saccharides other than lactose, the total amount of these saccharides can be calculated by subtracting the amount of dietary fiber from the amount of carbohydrates contained in the pasteurized fermented milk. The amount of carbohydrates contained in pasteurized fermented milk can be determined by subtracting the other basic nutritional components (moisture, protein, fat, and ash) from pasteurized fermented milk. The proportions of moisture, protein, fat, ash, and dietary fiber in pasteurized fermented milk can be measured according to standard methods in the food industry. Specifically, the water content can be measured according to the direct drying method. The protein content can be measured according to nitrogen quantification conversion, in which the total nitrogen content determined according to the Kjeldahl method is multiplied by a nitrogen protein conversion factor to determine the protein content. The ash content can be measured according to the dry direct ash method. The dietary fiber content can be measured by high-performance liquid chromatography (enzyme-HPLC method).

The water content of the pasteurized fermented milk of the present invention is set within the range of 75 to 90 mass %.

Satisfying the requirements for curd tension (X) and particle size after stirring (Y), the pasteurized fermented milk of the present invention exhibits suppressed coagulation of milk proteins and does not have a grainy texture despite being pasteurized (firm) fermented milk. Additionally, the pasteurized fermented milk gives a mouthfeel unique to set-type yogurt (a texture that disintegrates easily upon contact with the tongue in the mouth). Whether such texture is present can be evaluated by adjusting the target pasteurized fermented milk to a product temperature of 5° C. and then performing a sensory evaluation test with a specialist panel according to the method described in the Examples below.

### (II) Method for Producing Set-Type Pasteurized Fermented Milk

The pasteurized fermented milk of the present invention described above can be produced according to a method including the following steps A and B:
(a) a step of fermenting a starting-material milk mix to which lactic acid bacteria have been added in a container until the pH reaches 3.8 to 5.4 (“step A” or “fermentation step” below); and
(b) a step of heating the obtained fermented milk while it is in the container (“step B” or “heating step” below).

The production steps of the present invention described above may include, before step A, (1) a step of preparing a starting-material milk mix (starting-material milk mix preparation step), (2) a step of homogenizing the starting-material milk mix (homogenization step), and (3) a step of pasteurizing the starting-material milk mix (pre-pasteurization step). These are referred to as “pretreatment steps.” Of these pretreatment steps, homogenization step (2) and pre-pasteurization step (3) can be performed in any order. The starting-material milk mix prepared in step (1) may be subjected to homogenization step (2) and then pre-pasteurization step (3), or may be subjected to pre-pasteurization step (3) and then homogenization step (2). Homogenization step (2) and pre-pasteurization step (3) may also be performed simultaneously.

The production steps of the present invention described above may also include a step (4) of packing the starting-material milk mix obtained in pretreatment steps (1) to (3) in a container (packing step). Packing step (4) may be performed before lactic acid bacteria are added to the starting-material milk mix obtained in pretreatment steps (1) to (3), or may be performed after lactic acid bacteria are added to the starting-material milk mix obtained in pretreatment steps (1) to (3).

Although not limited, the production steps of the present invention preferably include the packing step after pretreatment steps (1) to (3) and before the addition of lactic acid bacteria in step A. In other words, it is preferable to pack the starting-material milk mix obtained in pretreatment steps (1) to (3) in a container and then subject it to step A, in which lactic acid bacteria are added to the starting-material milk mix packed in the container to allow the mix to ferment in the container.

Each step is described below.

### (1) Starting-Material Milk Mix Preparation Step

The “starting-material milk mix” targeted in the present invention is of a composition containing milk components derived from cow milk.

The starting-material milk mix is prepared using one or two or more raw materials selected from raw milk squeezed from cows, cow milk, skim milk, whole milk powder, skim milk powder, whole-milk concentrated milk, skim concentrated milk, sweetened condensed milk, sweetened condensed skim milk, unsweetened condensed milk, unsweetened condensed skim milk, whey, whey powder, desalted whey, desalted whey powder, whey protein concentrate (WPC), whey protein isolate (WPI), α-lactalbumin, β-lactoglobulin, milk protein concentrate (MPC), casein, sodium caseinate, calcium caseinate, cream, fermented cream, compound cream, cream powder, butter, fermented butter, buttermilk, buttermilk powder, butter oil, etc., preferably such that the fat content in the starting-material milk mix taken as 100 mass % (wet mass) is 6.5 mass % or less, preferably 6 mass % or less, and that the non-fat milk solids content is 8 to 16 mass %.

Additionally, when cow milk is used as a raw material, it is sufficient if the cow milk has been subjected to the pasteurization stipulated in the Ministerial Ordinance on Milk and Milk Products (Ministerial Ordinance Concerning Compositional Standards, etc. for Milk and Milk Products (Ministry of Health, Labor and Welfare: Ordinance No. 5 of Year 1951)), which states that milk should be pasteurized at 63° C. for 30 minutes using a holding method or using a method with an equivalent or greater antimicrobial effect. Pasteurization methods include low-temperature long-time pasteurization (LTLT) in a holding mode, low-temperature long-time pasteurization (LTLT) in a continuous mode, high-temperature long-time pasteurization (HTLT) in a holding mode, high-temperature short-time pasteurization (HTST), ultra-high-temperature pasteurization (UHT), and long-life pasteurization (LL). Of the milk sold in Japan, 90% is processed with UHT.

The starting-material milk mix can be prepared using only the milk components described above, but may also be prepared by, for example, adding, in addition to the milk components above, saccharides other than lactose derived from milk components (monosaccharides, disaccharides, oligosaccharides, polysaccharides, and sugar alcohols), to the extent that the effects of the present invention are not impaired.

The starting-material milk mix may have the following compositions:
(a) a fat content of 0.1 to 6.5 mass %, preferably 0.5 to 6 mass %, more preferably 1 to 4 mass %; non-fat milk solids content of 8 to 16 mass %, preferably 8.5 to 15.5 mass %, more preferably 8 to less than 15 mass %; and a saccharide content of 5 to 15 mass %, preferably 5 to 13 mass %, more preferably 5 to 12 mass %;
(b) a fat content of more than 0.5 mass % and 4 mass % or less, preferably 1 to 3.5 mass %; a non-fat milk solids content of 15 to 16 mass %, preferably more than 15 mass % and less than 16 mass %; and a saccharide content of 5 to 10 mass %, preferably 7 to 9 mass %, with the saccharides being lactose derived from starting-material milk, preferably containing no other saccharides (externally added saccharides); and
(c) a fat content of 0.5 mass % or less, preferably 0.1 to 0.5 mass; a non-fat milk solids content of 15 to 16 mass %, preferably more than 15 mass and less than 16 mass %; and a saccharide content of 5 to 15 mass %, preferably 8 to 15 mass %.

The starting-material milk mix may be prepared by further adding, in addition to the milk components and saccharides above, for example, fat, proteins other than whey protein and casein protein, minerals (salts), vitamins, flavor components, fragrances, colorants, and other food additives to the extent that the effects of the present invention are not impaired. Although this is not a strict limitation, it is preferable that the starting-material milk mix targeted by the present invention does not contain any components that fall under the category of gelling agents, thickeners, thickening stabilizers, or stabilizers (e.g., the stabilizers described in the Background Art section of the present specification, the β-glucan-containing material described in PTL 1, and the modified starch described in PTL 2).

The starting-material milk mix of the present invention is a composition containing water as well as the milk components. The proportion of water in the starting-material milk mix may be within the range of 75 to 90 mass %, preferably 78 to 89 mass %, and more preferably 81 to 88 mass %.

### (2) Homogenization Step

The step of homogenizing the starting-material milk mix refers to finely grinding (refining) particles composed of proteins and/or fat contained in the starting-material milk mix. The homogenization method can follow standard methods; examples of methods for use include, but are not limited to, stirring a starting-material milk mix using equipment such as a mixer or stirring blades, passing a starting-material milk mix through a narrow gap while pushing the mix by applying pressure, or passing a starting-material milk mix through a narrow gap while sucking the mix by reducing pressure. The method and equipment for homogenizing starting-material milk are not limited to these methods, and any known method and equipment can be used. As described in the Production Example below, a preferred method is to pressurize and extrude a starting-material milk mix through a narrow gap while heating the mix to about 70 to 90° C. (homogenizer). The pressure and flow rate (flow amount) used for homogenization may be appropriately set as long as the average particle size of the starting-material milk can be adjusted to 0.8 μm or less. For example, the homogenization pressure is 50 to 400 kg/cm², preferably 80 to 300 kg/cm², and more preferably 120 to 200 kg/cm². The homogenization can be performed once or multiple times. If homogenization is performed two or more times, it is preferable to set homogenization such that the total homogenization pressure falls within the above ranges. The flow rate (flow amount) is not limited, but is 50 to 1000 kg/h, preferably 75 to 500 kg/h, and more preferably 100 to 200 kg/h.

### (3) Pre-Pasteurization Step

The step of pasteurizing the starting-material milk mix is performed in order to pasteurize the starting-material milk mix until the number of bacteria (excluding spores) contained in the starting-material milk mix becomes 1000 cfu/ml or less. Any method and conditions that can achieve this purpose may be used, such as a heat treatment method used for pasteurizing milk. Examples of heat treatment methods used for pasteurizing milk include ultra-high-temperature pasteurization (UHT pasteurization) in which heat treatment is performed at 120 to 150° C. for 2 to 3 seconds, high-temperature short-time pasteurization (HTST pasteurization) in which heat treatment is performed continuously at 72 to 75° C. for 15 seconds or more, high-temperature long-time pasteurization (HTLT pasteurization) in which heat treatment is performed at 75° C. or higher for 15 minutes or more in a holding mode, high-temperature short-time pasteurization (HTST pasteurization) in which heat treatment is performed continuously at 72° C. or higher for 15 seconds or more, low-temperature long-time pasteurization (LTLT pasteurization) in which heat treatment is performed at 63 to 65° C. for 30 minutes in a holding mode, low-temperature long-time pasteurization in a continuous mode (LTLT pasteurization) in which heat treatment is performed continuously at 65 to 68° C. for 30 minutes or more, and long-life pasteurization (LL pasteurization) in which heat treatment is performed at 135 to 150° C. for 1 to 4 seconds.

The method is not limited to those described above, and any method can be used as long as the heat history represented by heating temperature (product temperature)×heating time×pressure is equal to or greater than that of the heat treatment methods described above. For example, a method used in the Experimental Example described below can also be used in which the starting-material milk mix is heated for 1 minute under normal pressure with a product temperature of 95° C.

### (4) Packing Step

As described above, the step of packing the starting-material milk mix in a container may be performed before the starting-material milk mix is fermented. For example, the step of packing the starting-material milk mix in a container may be performed after the homogenization step and pre-pasteurization step, and before or after adding starter lactic acid bacteria to the starting-material milk mix. The container in which the starting-material milk mix is packed may be any container commonly used in the production of fermented milk (dairy products) by post-fermentation, and there are no particular limitations on the size (volume), material, or shape. For example, the container may be of the size (volume) for one person for a single serving, or for family or commercial use. The container for use may be made of any material, such as plastic, glass, paper, or other materials. The container may be of any shape as long as it has strength and sealing properties; for example, the container may be of a cup shape, a brick pack shape, or a cheer pack shape. The method and equipment for filling the container may be commonly used methods and equipment.

### (A) Fermentation Step

In the present invention, the fermentation step can be performed by adding starter lactic acid bacteria to a starting-material milk mix and then fermenting the starting-material milk mix in a container. The lactic acid bacteria used as a starter may be one or a combination of two or more selected from lactic acid bacteria commonly used in the production of fermented milk, such as Lactobacillus bulgaricus (L. bulgaricus), Streptococcus thermophilus (S. thermophilus), Lactobacillus lactis (L. lactis), Lactobacillus gasseri (L. gasseri), Lactobacillus plantarum (L. plantarum), Lactobacillus casei (L. casei), Lactobacillus acidophilus (L. acidophilus), and Bifidobacterium. Preferably, the lactic acid bacteria is Lactobacillus bulgaricus. Additionally, from the perspective of being standardized as a yogurt starter in the Codex Alimentarius, a mixed starter of Lactobacillus bulgaricus and Streptococcus thermophilus is also usable.

The amount of the starter (lactic acid bacteria) added to the starting-material milk mix may be any amount commonly used in the production of fermented milk, and is, for example, 0.1 to 10 mass %, preferably 0.2 to 5 mass %, and more preferably 0.5 to 4 mass % relative to the starting-material milk mix. The starter may be added according to any method commonly used in the production of fermented milk, such as a method of aseptically adding the starter to a starting-material milk mix packed in a container, or a method of adding the starter in-line with the starting-material milk mix flowing through a pipe and then filling a container with the mixture. The method and equipment for adding the starter to the starting-material milk mix are not limited to the methods described above, and any known method and equipment can be used.

Fermentation of the starting-material milk mix can be performed by adding a starter (lactic acid bacteria) and then allowing the mix packed in a container to stand in a fermentation room set at a predetermined temperature. The conditions for fermenting the starting-material milk mix are adjusted taking into consideration the type and amount of lactic acid bacteria, etc. added to the starting-material milk, as well as the flavor, texture, physical properties, etc. of the fermented milk to be obtained.

For example, the lower limit of the temperature at which the starting-material milk mix is fermented (fermentation temperature) is preferably 35° C. or higher, and more preferably 37° C. or higher. The upper limit of the temperature at which the starting-material milk is fermented is preferably 50° C. or lower, and more preferably 45° C. or lower. Particularly preferred is 37 to 43° C. A low fermentation temperature is likely to result in a decrease in firmness of the obtained pasteurized fermented milk. Thus, the fermentation temperature can be adjusted so as to adjust the firmness of the pasteurized fermented milk as appropriate.

The time for fermenting starting-material milk (fermentation time) is the period until the pH of fermented milk falls within the range of 3.8 to 5.4. In other words, fermentation is ended when the pH of the fermented milk reaches a point within the range of 3.8 to 5.4. The pH at the end of fermentation can be set as follows according to the composition of the starting-material milk mix used:
(a) for a starting-material milk mix containing fat in an amount of 0.1 to 6.5 mass %, preferably 0.5 to 6 mass %, and more preferably 1 to 4 mass %; non-fat milk solids in an amount of 8 to 16 mass %, preferably 8.5 to 15.5 mass %, and more preferably 8 to less than 15 mass; and a saccharide in an amount of 5 to 15 mass %, preferably 5 to 13 mass %, and more preferably 5 to 12 mass %: the pH at the end of fermentation is 4.5 to 5.4, preferably 4.5 to 5.2, and more preferably 4.5 to 5.0;
(b) for a starting-material milk mix containing fat in an amount of more than 0.5 mass % and 4 mass % or less, and preferably 1 to 3.5 mass %; non-fat milk solids in an amount of 15 to 16 mass %, and preferably more than 15 mass % and less than 16 mass %; and a saccharide in an amount of 5 to 10 mass %, and preferably 7 to 9 mass % (wherein the saccharide is lactose derived from the starting-material milk, and preferably no other saccharides (externally added saccharides) are contained): the pH at the end of fermentation is 3.8 to less than 4.5, and preferably 4.0 to 4.4; and
(c) for a starting-material milk mix containing fat in an amount of 0.5 mass % or less, and preferably 0.1 to 0.5 mass %; non-fat milk solids in an amount of 15 to 16 mass %, and preferably more than 15 mass % and less than 16 mass %; and a saccharide in an amount of 5 to 15 mass %, and preferably 8 to 15 mass %: the pH at the end of fermentation is 3.8 to less than 4.5, and preferably 4.0 to 4.4.

When a starting-material milk mix with any of the following compositions is used, it is preferable to adjust the fermentation time so that the pH of the fermented milk does not fall within the range of 4.7 to 5.4, and preferably falls within the range of 3.8 to 4.5:
(d) a starting-material milk mix containing non-fat milk solids in an amount of 15 mass % or more and fat in an amount of 0.5 mass % or less; and
(e) a starting-material milk mix containing non-fat milk solids in an amount of 15 mass % or more and fat in an amount of more than 0.5 mass % and 4 mass % or less, and containing no saccharides (externally added saccharides) other than lactose derived from starting-material milk.

The pH at the end of fermentation is adjusted so as to fall within the above ranges depending on the composition of the starting-material milk mix; this provides set-type pasteurized fermented milk that exhibits suppressed coagulation of milk protein, which is an effect of the present invention, with a good texture (no graininess and good mouthfeel). The method and equipment used for fermenting the starting-material milk mix can be any known method and equipment.

### (B) Heating Step

The heating step is a step of heating the fermented milk that has reached a predetermined pH in the fermentation step, with the fermented milk packed in a container. This step is performed to kill the lactic acid bacteria added as a starter to the starting-material milk mix to prevent the progress of fermentation, and to kill bacteria to ensure the hygienic safety and expiration date of the food.

The heat treatment may be performed according to any method under any conditions that can achieve this purpose. A heat treatment method with the heat history represented by heating temperature (product temperature)×heating time×pressure being equal to or greater than 75° C.×15 minutes×normal pressure can be used. The heat history of 75° C.×15 minutes×normal pressure means that after the product temperature reaches 75° C. under normal pressure, the product is heated for 15 minutes under the same temperature conditions. An example of the heat treatment method that achieves a heat history of equal to or greater than 75° C.×15 minutes×normal pressure is a heat treatment in which a product is immersed in hot water at 85° C. for 60 minutes under normal pressure. Note that the normal pressure as used herein means that the pressure inside a container is normal pressure and does not include a pressure that has been artificially increased or decreased. The heat treatment may be performed after fermented milk packed in a container is packaged and sealed. Alternatively, fermented milk packed in a container may be heated before being sealed and packaged, and then sealed and packaged. Any known method and equipment can be used for heating fermented milk together with its container.

After being cooled, the pasteurized fermented milk thus produced can be directly distributed in the market in its state of being packed, sealed, and packaged in containers. As described in the Examples below, the pasteurized fermented milk obtained according to the production method of the present invention exhibits suppressed coagulation of milk proteins and has a good texture (no graininess and a pleasant mouthfeel). Thus, the production method of the present invention can provide firm, set-type pasteurized fermented milk that has overcome the conventional problems.

In the present specification, the terms “comprise” and “contain” include the meanings of consisting of and consisting essentially of.

### EXAMPLES

The present invention is described with reference to Experimental Examples in order to help to understand the elements and effects of the invention. However, the present invention is not limited in any way by these Experimental Examples. Unless otherwise specified, the following experiments were performed at room temperature (25±5° C.) under atmospheric pressure (normal pressure). Unless otherwise specified, the unit “%” below means mass %, and the unit “parts” below means parts by mass.

The raw materials used in the following Production Example (Examples and Comparative Examples) are as follows.

### Raw Materials

Cream: produced by Meiji Co., Ltd. (milk fat: 47%)
Milk (pasteurized with UHT, homogenized): produced by Meiji Co., Ltd.
Skim milk powder: produced by Meiji Co., Ltd. (non-fat milk solids: 96%, lactose: 55%)
High-heat skim milk powder: produced by Meiji Co., Ltd. (non-fat milk solids: 96%, lactose: 55%)
Whey protein isolate (WPI): WPI895 (whey protein: 93.5%) Fonterra Japan
Gelatin: M-200C Gelatin (produced by Nitta Gelatin Inc.)
Lactic acid bacteria starter: Lactobacillus bulgaricus OLL1073R-1 (1073R-1 lactic acid bacteria) isolated from Meiji Probio Yogurt R-1 (produced by Meiji Co., Ltd.)

### Production Example

### (1) Example 1

157 g of cream, 231 g of skim milk powder, and 2037 g of water were mixed to prepare starting-material milk (externally added saccharide: 0%, stabilizer: 0%). The starting-material milk was heated to about 70° C., then homogenized using a homogenizer at a flow rate of 150 L/h (100 kg/cm²+50 kg/cm²), and pasteurized by heat treatment at 95° C. for 5 minutes to prepare a starting-material milk mix. The obtained starting-material milk mix was cooled to 43° C., and a lactic acid bacteria starter was added (inoculated) in a proportion of 3%. Subsequently, the mix was then poured into a cup container (volume: 100 g, made of plastic) and left to stand in a fermentation room (43° C.) for 4 hours to allow fermentation to proceed until the pH reached 4.6, after which, the mix was cooled in a refrigerator (10° C. or lower). Thereafter, the cup container was immersed in hot water at 85° C. for 1 hour and then in ice-cold water for 30 minutes to obtain firm set-type pasteurized fermented milk (Example 1).

### (2) Example 2

Firm set-type pasteurized fermented milk (Example 2) was produced in the same manner as in Example 1, except that a composition (fat content: 0%, stabilizer: 0%) prepared by mixing 238 g of skim milk powder, 150 g of sugar, and 2038 g of water was used as starting-material milk.

### (3) Example 3

Firm set-type pasteurized fermented milk (Example 3) was produced in the same manner as in Example 1, except that a composition prepared by mixing 157 g of cream, 231 g of skim milk powder, 150 g of sugar, and 1887 g of water (containing fat and externally added saccharides with no stabilizer (0%)) was used as starting-material milk.

### (4) Example 4

Firm set-type pasteurized fermented milk (Example 4) was produced in the same manner as in Example 1, except that a composition prepared by mixing 315 g of cream, 223 g of skim milk powder, 150 g of sugar, and 1738 g of water (containing fat and externally added saccharides with no stabilizer (0%)) was used as starting-material milk.

### (5) Example 5

Firm set-type pasteurized fermented milk (Example 5) was produced in the same manner as in Example 1, except that a composition prepared by mixing 154 g of cream, 379 g of skim milk powder, 150 g of sugar, and 1743 g of water (containing fat and externally added saccharides with no stabilizer (0%)) was used as starting-material milk.

### (6) Examples 6 to 8

Using starting-material milk (containing fat and externally added saccharides with no stabilizer (0%)) of the same formula as in Example 3, firm set-type pasteurized fermented milk (Examples 6 to 8) was obtained according to the method and conditions described in Example 1, except that the homogenization pressure used in homogenization and the temperature used in fermentation treatment were as described in Table 1.

### (7) Examples 9 to 12

Using starting-material milk (containing fat and externally added saccharides with no stabilizer (0%)) of the same formula as in Example 3, firm set-type pasteurized fermented milk (Examples 9 to 12) was obtained according to the same method under the same conditions as in Example 1, except that the pH at the end of fermentation was set as shown in Table 1.

### (8) Examples 13 and 14

Using starting-material milk (externally added saccharide: 0%, stabilizer: 0%) of the same formula as in Example 1, firm set-type pasteurized fermented milk (Examples 13 and 14) was obtained according to the same method under the same conditions as in Example 1, except that the pH at the end of fermentation was set as shown in Table 1.

### (9) Example 15

Starting-material milk (externally added saccharides: 0%, stabilizer: 0%) composed of cow milk (UHT pasteurized and homogenized) and high-heat skim milk powder, which were replacement of cream and skim milk powder, and water was prepared to have the same formula as in Example 1, and firm set-type pasteurized fermented milk (Example 15) was obtained according to the same method under the same conditions as in Example 1.

### (10) Example 16

Starting-material milk (externally added saccharides: 0%, stabilizer: 0%) composed of cream, (UHT pasteurized and homogenized) cow milk and high-heat skim milk powder, which were replacement of skim milk powder, and water was prepared to have the same formula as in Example 1, and firm set-type pasteurized fermented milk (Example 16) was obtained according to the same method under the same conditions as in Example 15, except that the fermentation temperature was as shown in Table 1.

### (11) Comparative Examples 1 to 6

Using starting-material milk (externally added saccharides: 0%, stabilizer: 0%) of the same formula as in Example 1, firm set-type pasteurized fermented milk (Comparative Examples 1 to 6) was obtained in the same manner under the same conditions as in Example 1, except that the pH at the end of fermentation was set as shown in Table 2.

Table 1 shows the formulas of the starting-material milk (the proportion of fat, non-fat milk solids, lactose, externally added saccharides, and total saccharides) and production conditions (homogenization pressure, fermentation temperature, and pH at the end of fermentation) for Examples 1 to 16, and Table 2 shows the formulas of the starting-material milk and production conditions for Comparative Examples 1 to 6.

TABLE 1

| | Formula | | | | | Production Conditions | | |
|---|---|---|---|---|---|---|---|---|
| | | Non-fat Milk | | Externally Added | Total | Homogenization | Fermentation | pH at End of |
| | Fat | Solids | Lactose | Saccharides | Saccharides | Pressure | Temperature | Fermentation |
| | (%) | (%) | (%) | (%) | (%) | kg/cm² | ° C. | pH |
| Example 1 | 3.05 | 9.42 | 5.28 | 0 | 5.28 | 100 + 50 | 43 | 4.6 |
| Example 2 | 0.1 | 9.36 | 5.24 | 6 | 11.24 | 100 + 50 | 43 | 4.6 |
| Example 3 | 3.05 | 9.42 | 5.28 | 6 | 11.28 | 100 + 50 | 43 | 4.6 |
| Example 4 | 6.01 | 9.38 | 5.25 | 6 | 11.25 | 100 + 50 | 43 | 4.6 |
| Example 5 | 3.05 | 15.04 | 8.43 | 6 | 14.43 | 100 + 50 | 43 | 4.6 |
| Example 6 | 3.05 | 9.42 | 5.28 | 6 | 11.28 | 100 + 50 | 37 | 4.6 |
| Example 7 | 3.05 | 9.42 | 5.28 | 6 | 11.28 | 350 + 50 | 43 | 4.6 |
| Example 8 | 3.05 | 9.42 | 5.28 | 6 | 11.28 | 350 + 50 | 37 | 4.6 |
| Example 9 | 3.05 | 9.42 | 5.28 | 6 | 11.28 | 100 + 50 | 43 | 5.4 |
| Example 10 | 3.05 | 9.42 | 5.28 | 6 | 11.28 | 100 + 50 | 43 | 5 |
| Example 11 | 3.05 | 9.42 | 5.28 | 6 | 11.28 | 100 + 50 | 43 | 4.7 |
| Example 12 | 3.05 | 9.42 | 5.28 | 6 | 11.28 | 100 + 50 | 43 | 4.4 |
| Example 13 | 3.05 | 15.04 | 8.43 | 0 | 8.43 | 100 + 50 | 43 | 4.4 |
| Example 14 | 0.16 | 15.04 | 8.43 | 6 | 14.43 | 100 + 50 | 43 | 4.4 |
| Example 15 | 3.05 | 9.42 | 5.28 | 0 | 5.28 | 100 + 50 | 43 | 4.6 |
| Example 16 | 3.05 | 9.42 | 5.28 | 0 | 5.28 | 100 + 50 | 37 | 4.6 |

TABLE 2

| | Formula | | | | | Production Conditions | | |
|---|---|---|---|---|---|---|---|---|
| | | Non-fat Milk | | Externally Added | Total | Homogenization | Fermentation | pH at End of |
| | Fat | Solids | Lactose | Saccharides | Saccharides | Pressure | Temperature | Fermentation |
| | (%) | (%) | (%) | (%) | (%) | Mpa | ° C. | pH |
| Comparative | 3.05 | 15.04 | 8.43 | 0 | 8.43 | 100 + 50 | 43 | 5.4 |
| Example 1 | | | | | | | | |
| Comparative | 3.05 | 15.04 | 8.43 | 0 | 8.43 | 100 + 50 | 43 | 5 |
| Example 2 | | | | | | | | |
| Comparative | 3.05 | 15.04 | 8.43 | 0 | 8.43 | 100 + 50 | 43 | 4.7 |
| Example 3 | | | | | | | | |
| Comparative | 0.16 | 15.04 | 8.43 | 6 | 14.43 | 100 + 50 | 43 | 5.4 |
| Example 4 | | | | | | | | |
| Comparative | 0.16 | 15.04 | 8.43 | 6 | 14.43 | 100 + 50 | 43 | 5 |
| Example 5 | | | | | | | | |
| Comparative | 0.16 | 15.04 | 8.43 | 6 | 14.43 | 100 + 50 | 43 | 4.7 |
| Example 6 | | | | | | | | |

### Experimental Examples

The pasteurized fermented milk of Examples 1 to 16 and Comparative Examples 1 to 6 produced in the Production Example above was evaluated for curd tension (firmness), particle size after stirring, centrifugal syneresis, and texture (smoothness) according to the following methods.

### (A) Curd Tension (Firmness)

The pasteurized fermented milk of Examples 1 to 16 and Comparative Examples 1 to 6 was immersed in hot water at 85° C. for 1 hour in the production step above and then immersed in ice-cold water for 30 minutes to adjust the product temperature to 5° C., followed by measuring their curd tension (firmness) with a MAX ME-500 curd meter (produced by I. Techno Engineering).

Specifically, a yogurt knife with a 100 g weight attached was placed on the top surface of a test sample (pasteurized fermented milk), and the test sample was continuously raised while a load was applied at about 2 g/sec. The measured load was plotted as a curve in accordance with the time of the load applied. At this time, the time of the load applied (seconds) was plotted on the vertical axis, and the measured load value was plotted on the horizontal axis, with 10 g on the vertical axis and 4 seconds on the horizontal axis being the same distance. When the test sample breaks, an inflection point (breaking point) appears on this time-weighted curve due to penetration of the yogurt knife into the top surface of the test sample. The load applied until the curd breaks was defined as the curd tension (g).

(B) Particle Size after Stirring

The pasteurized fermented milk of Examples 1 to 16 and Comparative Examples 1 to 6, which was in a cup container, was immersed in hot water at 85° C. for 1 hour together with the cup container and then immersed in ice-cold water for 30 minutes to adjust the product temperature to 5° C. in the production step above. Thereafter, the pasteurized fermented milk was subjected to stirring treatment described below, and the resulting stirred products were measured for particle size with a SALD-2200 laser diffraction particle size distribution analyzer (produced by Shimadzu Corporation).

### Stirring Treatment

500 g of pasteurized fermented milk (test sample) was placed in a cylindrical stainless steel tray (bottom area: 123 cm²) and stirred at 150 rpm for 1 minute at room temperature (25° C.) with a stirrer (Three-One Motor FBLh1200M: produced by Shinto Scientific Co., Ltd., paddle shape: T-shaped, paddle radius: 6 cm).

### Method for Measuring Particle Size

The pasteurized fermented milk of Examples 1 to 16 and Comparative Examples 1 to 6 was measured for average particle size and standard deviation with a SALD-2200 laser diffraction particle size distribution analyzer (produced by Shimadzu Corporation). Specifically, the pasteurized fermented milk was diluted with ion-exchanged water such that the maximum value of the distribution of the diffracted and scattered light intensity was 35 to 75%. The light intensity distribution was then analyzed using WingSALD II software for particle size distribution analyzers to determine the average particle size±standard deviation.

### (C) Centrifugal Syneresis

The pasteurized fermented milk of Examples 1 to 16 and Comparative Examples 1 to 6, which was in a cup container, was immersed in hot water at 85° C. for 1 hour together with the cup container and then immersed in ice-cold water for 30 minutes to adjust the product temperature to 5° C. in the production step above. Thereafter, the pasteurized fermented milk was subjected to centrifugation described below, and the resulting centrifuged products were measured to calculate the amount of syneresis (%) according to the measurement method described below.

### Centrifugation

The pasteurized fermented milk (product temperature: 5° C.) of Examples 1 to 16 and Comparative Examples 1 to 6 was weighed to give 40 g and placed in a centrifuge tube, followed by centrifuging the tube at 3000 rpm at 5° C. for 10 minutes with an LCX-100 centrifuge (Tomy Sieko Co., Ltd.).

### Method for Measuring Amount of Syneresis

After centrifugation, the weight of the liquid separated into the upper layer of the centrifuged product was measured, and the amount of syneresis (%) was calculated using the following formula.

Amount of syneresis (%)=weight of separated liquid (g)/40 (g)×100

### (D) Texture (Smoothness)

The pasteurized fermented milk of Examples 1 to 16 and Comparative Examples 1 to 6 was immersed in hot water at 85° C. for 1 hour and then immersed in ice-cold water for 30 minutes to adjust the product temperature to 5° C. in the production step above, after which a panel of five experts tasted each milk product and evaluated their texture (smoothness).

The panel of experts was composed of specialists involved in the research and development of fermented milk and routinely evaluating the texture of firm, set-type fermented milk. Each expert put 10 g of the pasteurized fermented milk of each Example into their mouth at one time and evaluated the smoothness based on the mouthfeel and whether graininess was felt by the tongue as indicators. The mouthfeel was evaluated as “good mouthfeel” if it felt like the fermented milk smoothly disintegrated when being put in the mouth and came in contact with the tongue, and evaluated as “poor mouthfeel” if some granules remained when the fermented milk was put in the mouth and came in contact with the tongue.

Each expert conducted three tastings for one pasteurized fermented milk sample to examine the mouthfeel and whether graininess was present. The results from each expert were collected and discussed among them to make a comprehensive evaluation based on the following criteria.

### Comprehensive Evaluation

o: Throughout the three tastings, the mouthfeel was generally good, and there was no graininess (smooth texture).
Δ: Throughout the three tastings, the mouthfeel was generally good, but there was slight graininess
x: Throughout the three tastings, regardless of the mouthfeel, there was clear graininess overall, or although there was no graininess, the mouthfeel was poor.

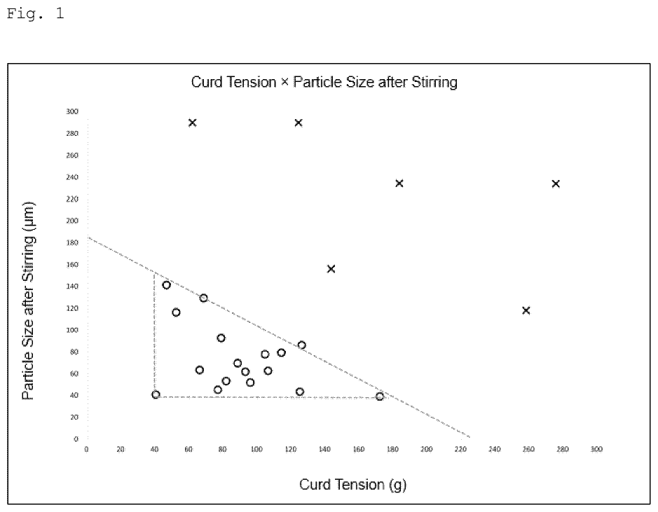

Table 3 shows the evaluation results of Examples 1 to 16, and Table 4 shows the evaluation results of Comparative Examples 1 to 6. FIG. 1 shows a graph in which the textures (o, x) of Examples 1 to 16 and Comparative Examples 1 to 6 are plotted with the curd tension (g) on the horizontal axis and the particle size after stirring (μm) on the vertical axis.

TABLE 3

| | Curd | Particle Size | Centrifugal | |
|---|---|---|---|---|
| | Tension | after Stirring | Syneresis | Texture |
| | (g) | (μm) | (%) | (Smoothness) |
| Example 1 | 88.5 | 69.5 | 39.8 | ∘ |
| Example 2 | 78.8 | 92.7 | 44.2 | ∘ |
| Example 3 | 96.0 | 51.8 | 22.9 | ∘ |
| Example 4 | 125.1 | 43.4 | 0.1 | ∘ |
| Example 5 | 172.1 | 38.9 | 0.9 | ∘ |
| Example 6 | 81.8 | 53.3 | 16.2 | ∘ |
| Example 7 | 106.4 | 62.6 | 11.0 | ∘ |
| Example 8 | 76.9 | 45.2 | 7.9 | ∘ |
| Example 9 | 46.7 | 141.3 | 35.3 | ∘ |
| Example 10 | 68.5 | 129.3 | 33.5 | ∘ |
| Example 11 | 104.6 | 77.8 | 28.9 | ∘ |
| Example 12 | 66.2 | 63.3 | 29.0 | ∘ |
| Example 13 | 126.2 | 86.2 | 20.9 | ∘ |
| Example 14 | 114.2 | 79.3 | 32.5 | ∘ |
| Example 15 | 52.3 | 116.3 | 47.5 | ∘ |
| Example 16 | 40.3 | 40.8 | 9.2 | ∘ |

TABLE 4

| | Curd | Particle Size | Centrifugal | |
|---|---|---|---|---|
| | Tension | after Stirring | Syneresis | Texture |
| | (g) | (μm) | (%) | (Smoothness) |
| Comparative | 124.2 | 290.0 | 38.5 | x |
| Example 1 | | | | |
| Comparative | 183.5 | 234.5 | 51.5 | x |
| Example 2 | | | | |
| Comparative | 143.4 | 156.2 | 33.7 | x |
| Example 3 | | | | |
| Comparative | 61.9 | 290.0 | 54.0 | x |
| Example 4 | | | | |
| Comparative | 275.6 | 234.2 | 58.5 | x |
| Example 5 | | | | |
| Comparative | 258.1 | 118.1 | 37.0 | x |
| Example 6 | | | | |

As shown in FIG. 1, the pasteurized fermented milk of Examples 1 to 16 had a curd tension and a particle size after stirring within predetermined ranges and was therefore confirmed to have a good texture. Specifically, unlike the pasteurized fermented milk of Comparative Examples 1 to 6, the pasteurized fermented milk of Examples 1 to 16 has a curd tension (X) within the range of 20 to 220 g, preferably 35 to 180 g, and more preferably 40 to 175 g; a particle size after stirring (Y) within the range of 166.5 to 2.5 μm, preferably 150 to 30 μm, and more preferably 145 to 35 μm; and the curd tension (X) and the particle size after stirring (Y) are within the range represented by the following formula, thus showing a smooth and good texture: Y≤−0.82X+183

Additionally, most of the pasteurized fermented milk of Examples 1 to 16 exhibited less centrifugal syneresis as compared to that of Comparative Examples 1 to 6.

### INDUSTRIAL APPLICABILITY

Currently, the market for pasteurized fermented milk is expanding not only in Japan but also overseas (especially in China). Since pasteurized fermented milk has a longer shelf life, it can be sold in a less developed distribution environment as compared to regular fermented milk, and the requirements for cooling facilities at retailers can also be relaxed. Additionally, pasteurized fermented milk may have a long expiration date, which allows for more flexible production plans and reduces food waste. However, the existing formulations of pasteurized fermented milk are limited to drinking yogurt and soft yogurt, and there has been no firm, set-type pasteurized fermented milk. The present invention can provide firm pasteurized fermented milk, which can bring about benefits such as development of new markets, improvement of productivity, and reduction of environmental burden.

1. A set-type pasteurized fermented milk having curd tension (X) and particle size after stirring (Y) that satisfy the following conditions:
a curd tension (X) of 20 g to 220 g,
a particle size after stirring (Y) of 166.5 μm to 2.5 μm, and
$$Y \leq - 0.82 X + 183 .$$

2. The pasteurized fermented milk according to claim 1, wherein the curd tension (X) is 35 g or more.

3. The pasteurized fermented milk according to claim 1, comprising fat in an amount of 6 mass % or less and non-fat milk solids in an amount of 8 to 16 mass %, and having a pH of 3.8 to 5.4,
with the proviso that the pasteurized fermented milk containing the non-fat milk solids in an amount of 15 mass % or more and the fat in an amount of 0.5 mass % or less or the pasteurized fermented milk containing the non-fat milk solids in an amount of 15 mass % or more and containing no externally added saccharide has a pH of 3.8 to 4.5.

4. The pasteurized fermented milk according to claim 3, comprising a saccharide in an amount of 15 mass % or less.

5. A method for producing the pasteurized fermented milk of claim 1, comprising the steps of
fermenting a starting-material milk mix to which lactic acid bacteria are added in a container at 37° C. to 43° C. until the pH reaches 3.8 to 5.4, and
heating the obtained fermented milk together with the container.

6. The method according to claim 5, wherein the starting-material milk mix is subjected to homogenization and pasteurization before the lactic acid bacteria are added.

7. The method according to claim 5,
wherein the starting-material milk mix contains fat in an amount of 6 mass % or less and non-fat milk solids in an amount of 8 to 16 mass %,
with the proviso that
when the starting-material milk mix contains the non-fat milk solids in an amount of 15 mass % or more and the fat in an amount of 0.5 mass % or less, or when the starting-material milk mix contains the non-fat milk solids in an amount of 15 mass % or more and contains no externally added saccharide, the starting-material milk mix is fermented until the pH reaches 3.8 to 4.5.

8. The method according to claim 7, wherein the starting-material milk mix contains a saccharide in an amount of 15 mass % or less.
